(19) United States
(12) Patent Application Publication
(10) Pub. No.: US 2012/0131339 A1
(43) Pub. Date: May 24, 2012

(54) SYSTEM AND METHOD FOR SECURE BI-DIRECTIONAL COMMUNICATION

(75) Inventors: Geetha Mangalore, San Diego, CA (US); Petr Peterka, San Diego, CA (US)

(73) Assignee: GENERAL INSTRUMENT CORPORATION, Horsham, PA (US)

(21) Appl. No.: 12/950,700

(22) Filed: Nov. 19, 2010

(51) Int. Cl. H04L 9/32

(52) U.S. Cl. 713/168

(57) ABSTRACT

An aspect of the present invention provides a method of communicating within a system having a first device, a second device, a key distribution device and an interactive service portal device. The method includes: storing a tag within the interactive service portal device; associating the tag with the first device; registering the first device with the key distribution device; associating, by way of the key distribution device, an encryption key with the first device; accessing, by way of the second device, the tag; providing information to the second device; and establishing secure bi-directional interactive communication, corresponding to the tag, between the first device and the second device based on a relationship between the information and the encryption key.

### BACKGROUND

Video conferencing equipment is available for providing interactive applications between remotely located persons via global networks, e.g., the Internet. Interactive applications include exchanges of audio, video, media and other information. Conventional video conferencing between people often requires bulky and expensive equipment in addition to expensive high-bandwidth connections.

An increasing need and demand for delivering cost effective peer-to-peer interactive applications for providing value to customers and service providers is being experienced in the market place. Non-limiting examples of interactive peer-to-peer applications include private tutoring, medical consulting and other consulting services of high commercial value. Teaching and consulting services provided interactively, securely and bi-directionally by a teacher at his/her location to/from students at their location or locations is a highly sought application. Providing security for an interactive, bi-directional teaching or consulting service is a high priority of service providers, as service providers seek to protect the value of the material presented. For example, in medical consulting, privacy of patient related information is a key issue requiring the application of secure exchanges of information.

A set-top box is a device that connects to a television (or other display device) and an external source of signal, turning the signal into content which is then displayed on the television screen (or other display device). Conventional set-top boxes provided by media providers operate to supply audio, video, media and other information via media networks for viewing by users on televisions and other video capable devices. However, conventional media provider networks and associated set-top boxes are generally not capable of providing interactive, secure and bi-directional exchanges of information between users and service providers.

In view of the foregoing, there is a need for improved techniques for providing interactive, secure, bi-directional and cost effective exchanges of information between users and service providers using networks and associated equipment of media providers.

### BRIEF SUMMARY

In accordance with aspects of the present invention, a system and method is provided for interactive, secure, bi-directional and cost effective exchanges of information between users and service providers using networks and associated equipment of media providers.

In accordance with an aspect of the present invention, a method is provided of communicating within a system having a first device, a second device, a key distribution device and an interactive service portal device. The method includes: storing a tag within the interactive service portal device; associating the tag with the first device; registering the first device with the key distribution device; associating, by way of the key distribution device, an encryption key with the first device; accessing, by way of the second device, the tag; providing information to the second device; and establishing secure bi-directional interactive communication, corresponding to the tag, between the first device and the second device based on a relationship between the information and the encryption key.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a block diagram of a communication system, an exemplary embodiment of the present invention;

FIG. 2 illustrates a detailed version of a set-top box illustrated in FIG. 1, an exemplary embodiment of the present invention;

FIG. 3 illustrates a detailed version of a key distribution device illustrated in FIG. 1, an exemplary embodiment of the present invention;

FIG. 4 illustrates a detailed version of an interactive service portal as illustrated in FIG. 1, an exemplary embodiment of the present invention;

FIG. 5 illustrates a detailed version of a billing server as illustrated in FIG. 1, an exemplary embodiment of the present invention;

FIG. 6 presents a block diagram illustrating information flows as related to elements of FIG. 1, in accordance with an exemplary embodiment of the present invention; and

FIG. 7A-D presents a flow chart illustrating an exemplary method for interaction of the elements of a communication system as illustrated in FIG. 1 and FIG. 6, in accordance with an exemplary embodiment of the present invention.

### DETAILED DESCRIPTION

A first embodiment of the present invention provides for secure interactive bi-directional communications between a plurality of communication devices with interaction for communication between the communication devices aided by a communication network, key distribution device and an interactive service portal.

Aspects of the present invention may be used with bi-directional communication devices, non-limiting examples of which include phones, computers and set-top boxes. For consistency of discussion, examples embodiments discussed herein may use the non-limiting example of a communications system using set-top boxes. Set-top boxes, key distribution device and interactive service portal may be arranged to communicate via communication network. Non-limiting examples of communication networks which may be supported include Ethernet, optical fiber, Local Area Network (LAN), Wireless LAN (WLAN), Internet, cable, cellular, satellite and power line.

Users may exchange information, execute applications and view video provided via media providers. Non-limiting examples of media providers include cable, satellite and Internet. A multiplicity of users may interface with a given provider, with each user having a unique account.

Non-limiting example of information exchanged include audio, video, text files, graphic files, facsimiles, email, chat, social networking and other application files. Non-limiting example of applications that may be executed include network browsing, word processing, spreadsheet, graphics, audio related and video related.

Set-top boxes may include devices for interaction with users. Non-limiting examples of devices with which set-top boxes may provide for interacting with users include Graphical User Interfaces (GUIs), cameras, monitors, televisions, keyboards, keypads, touch-screens, trackballs, pointing devices, mouses, audio speakers, facsimiles, printers and scanners.

Prior to the initiation of secure interactive bi-directional communications between the set-top boxes, a user may initiate registration with key distribution device. Key distribution device may verify a user maintains an account in good standing prior to providing a security key to the user.

After verifying a user's account is in good standing, key distribution device may provide a security key to the set-top box interfacing with user. A user, after receiving a valid security key, may browse interactive service portal for services.

A user finding a service or services for participation may select the service or services. Following selection of a service or services, user's associated set-top box may request a tag from key distribution service. Following verification of service by supplier of service, user's set-top box may be supplied a security key by set-top box of service provider. Following receipt of security key from service provider's set-top box, user's set-top box may verify validity of security key provided by service provider's set-top box.

Following receipt of valid security key, user and service provider may communicate via their associated set-top boxes in a secure and bidirectional manner. Following completion of communication between user and service provider, user's account status and service provider's account status may be updated. Non-limiting example of information which may be updated include account of user (or service provider), name of user, address of user, telephone number of user, length of session, cost of session, location of session, title of session, content of session and date of session.

In other embodiments of the present invention, a method and means will be described which provides for billing of secure interactive bi-directional communications between a multiplicity of set-top boxes with interaction for communication between the set-top boxes aided by a communication network, key distribution device, an interactive service portal and a billing server. Non-limiting examples of billing which may be supported include debit/credit of credit cards, debit/credit of debit cards and debit/credit of banking accounts.

In other embodiments of the present invention, a method and means will be described which provides for recording and playback of secure interactive bi-directional communications between a multiplicity of set-top boxes with interaction for communication between the set-top boxes aided by a communication network, a key distribution device and an interactive service portal. Non-limiting example of information which may be recorded for playback may include audio, video, text files, graphic files, facsimiles, email, chat, social networking and application files.

In other embodiments of the present invention, a system and method provides for recording, playback and billing of secure interactive bi-directional communications between a multiplicity of set-top boxes with interaction for communication between the set-top boxes aided by a communication network, a key distribution device, an interactive service portal and a billing server. Non-limiting examples of billing which may be supported include debit/credit of credit cards, debit/credit of debit cards and debit/credit of banking accounts. Non-limiting example of information which may be recorded for playback may include audio, video, text files, graphic files, facsimiles, email, chat, social networking and application files.

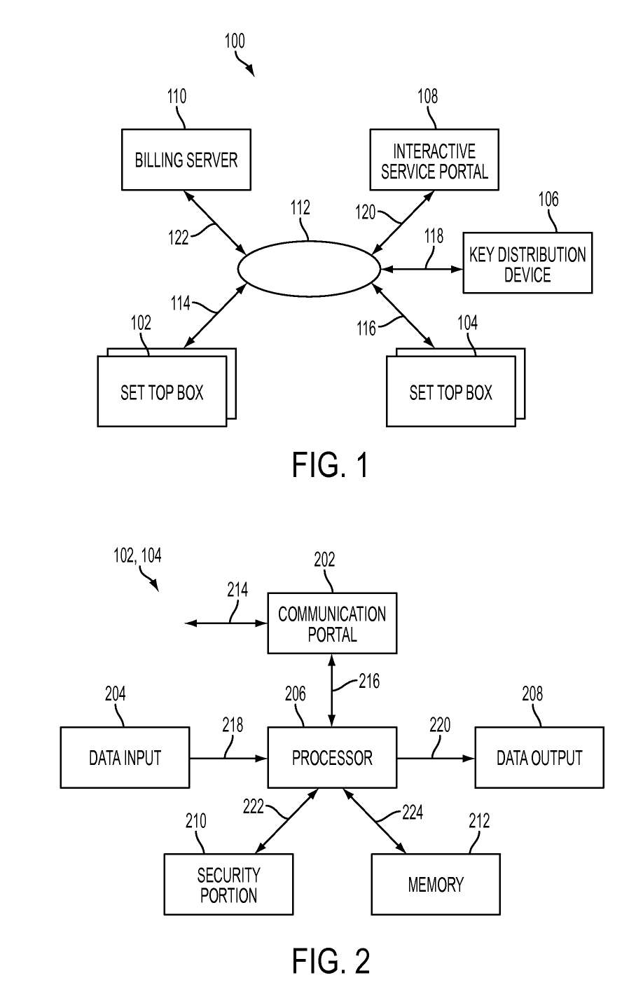

FIG. 1 illustrates a block diagram of an example communication system 100 in accordance with an aspect of the present invention.

Communication system 100 includes a plurality of set-top boxes, with a sampling denoted as a set-top box 102 and a set-top box 104, a key distribution device 106, an interactive service portal 108, a billing server 110 and a communications network 112. Each of the elements of communication system 100 are illustrated as individual devices, however, in some embodiments of the present invention at least two of key distribution device 106, interactive service portal 108 and billing server 110 may be combined as a unitary device.

Set-top box 102 may communicate bi-directionally with communications network 112 via a communication channel 114. Set-top box 104 may communicate bi-directionally with communications network via a communication channel 116. Key distribution device 106 may communicate with communications network 112 via a communication channel 118. Interactive service portal 108 may communicate with communications network 112 via a communication channel 120. Billing server 110 may communicate bi-directionally with communications network 112 via a communication channel 122. Set-top box 102, set-top box 104, key distribution device 106, interactive service portal 108 and billing server 110 may each communicate bi-directionally with one another via communications network 112, communication channel 114, communication channel 116, communication channel 118, communication channel 120 and communication channel 122.

Set-top box 102 and set-top box 104 may interface with a user for communicating information to/from external entities via communications network 112 and to perform other media and computing functions. Key distribution device 106 may receive, process and transmit responses to requests for security and tag related information. Interactive service portal 108 may receive and process requests for service related information. Billing server 110 may receive and process requests for billing related information and communicate billing related operations.

FIG. 2 illustrates a more detailed view of example set-top box 102 in accordance with an aspect of the present invention. FIG. 2 also illustrates a more detailed view of example set-top box 104 in accordance with an aspect of the present invention.

Set-top box 102 includes a communication portion 202, a data input 204, a processor 206, a data output 208, a security portion 210 and a memory 212. Each of the elements of set-top box 102 are illustrated as individual devices, however, in some embodiments of the present invention at least two of communication portion 202, data input 204, processor 206, data output 208, security portion 210 and memory 212 may be combined as a unitary device.

Communication portion 202 may bi-directionally communicate with external entities (not shown) via a communication channel 214 and with processor 206 via a communication channel 216. Processor 206 may receive information from data input 204 via a communication channel 218, communicate bi-directionally with security portion 210 via a communication channel 222 and communicate bi-directionally with memory 212 via a communication channel 224. Data output 208 may receive information from processor 206 via a communication channel 220 and to transmit information to a user (not shown). Data input 204 may receive information from user.

Set-top box 102 may present information to a user via data output 208. Non-limiting examples of data output 208 include Graphical User Interface (GUI), computer monitor, computer display, gaming system display, television, display of mobile device, audio speaker and printer.

Set-top box 102 may receive information from a user via data input 204. Non-limiting examples of data input 204 include a camera, a mouse, a trackball, a keyboard, a keypad, a touch-screen, a pointing device and a scanner. Set-top box 102 may communicate with external devices via communication portion 202. Non-limiting examples of networks which communication portion 202 may communicate with include Ethernet, optical fiber, Local Area Network (LAN), Wireless LAN (WLAN), Internet, cable, cellular, satellite and power line.

Processor 206 may execute operational codes retrieved from memory 212 and to store and retrieve information to/from memory 212. Non-limiting examples of memory include Random Access Memory (RAM), Dynamic Random Access Memory (DRAM), Read-Only Memory (ROM), Digital Video Disk (DVD), Compact Disk Read-Only Memory (CDROM), Hard Disk (HD) and flash memory. Non-limiting examples of software languages for which operational codes for processor 206 may be compiled and assembled from include “C”, “C++”, “C#” and Java.

Security portion 210 may perform encryption of information using security keys to be transmitted via communication portion 202 and decryption of information received via communication portion 202 using security keys.

In operation, communication portion 202 of set-top box 102 may receive information via communication channel 214. Communication portion 202 may communicate received information to processor 206 via communication channel 216. Processor 206 may communicate received information to memory 212 via communication channel 224. Processor 206 may then determine the security status of received information. For encrypted received information, processor 206 may retrieve decryption keys from memory 212 and encrypted received information from memory 212 and then communicate encrypted information and decryption keys to security portion 210 for decryption.

Security portion 210 may then decrypt encrypted received information using decryption keys. Processor 206 may then operate to receive decrypted information from security portion 210 for processing. Non-limiting examples of processing for which processor 206 may engage include executing algorithms and communicating information to data output 208 via communication channel 220 for user to view, listen and print.

A user presented information by data output 208 may communicate information to be transmitted to external entities. User may present information to be communicated via data input 204. Data input 204 may communicate the information to be transmitted to processor 206 via communication channel 218. For information to be securely transmitted, processor 206 may retrieve encryption keys from memory 212 via communication channel 224 and communicate encryption keys and information to be transmitted to security portion 210 via communication channel 222. Security portion 210 may encrypt information to be transmitted using encryption keys. Security portion 210 may communicate encrypted information to be transmitted to processor 206 via communication channel 222. Processor 206 may communicate encrypted information to be transmitted to communication portion 202 via communication channel 216. Communication portion 202 may transmit encrypted information externally to set-top box 102 via communication channel 214.

Set-top box 102 may interface with a user for communicating information to/from external entities via a communication network and to perform other media and computing functions.

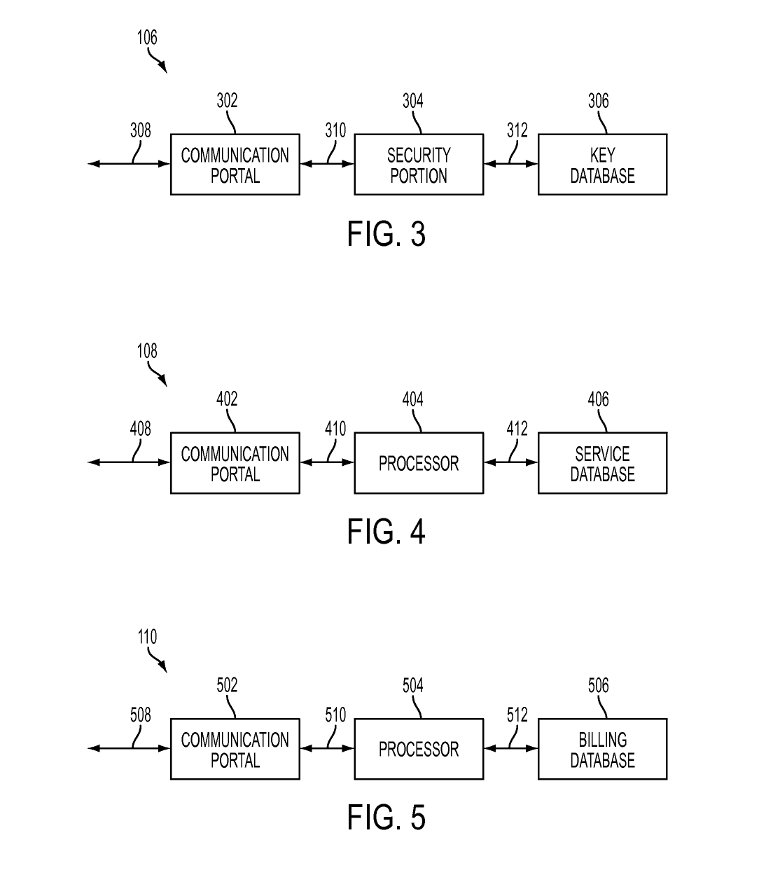

FIG. 3 illustrates a detailed version of key distribution device 106, an exemplary embodiment of the present invention.

Key distribution device 106 includes a communication portion 302, a security portion 304 and a key database 306. Each of the elements of key distribution device 106 are illustrated as individual devices, however, in some embodiments of the present invention at least one of communication portion 302, security portion 304 and key database 306 may be combined as a unitary device.

Communication portion 302 may communicate bi-directionally with external entities (now shown) via a communication channel 308 and with security portion 304 via a communication channel 310. Security portion 304 may communicate bi-directionally with key database 306 via a communication channel 312.

Key distribution device 106 may communicate with external devices via communication portion 302. Non-limiting examples of networks which communication portion 302 may communicate with include Ethernet, optical fiber, Local Area Network (LAN), Wireless LAN (WLAN), Internet, cable, cellular, satellite and power line.

Security portion 304 may receive information from communication portion 302 via communication channel 310. Non-limiting example of information security portion 304 may receive from communication portion 302 include requests for registration, authentication, creation of new security keys and creation of new tags.

Security portion 304 may process requests and store associated information in key database 306. Following receipt of a request, security portion 304 may retrieve associated information from key database 306, process information received and retrieved and communicate a response to communication portion 302. Communication portion 302 may receive information from security portion 304 for communication to external entities via communication channel 308.

Key distribution device 106 may receive, process and transmit responses to requests for security and tag related information.

FIG. 4 illustrates a detailed version of interactive service portal 108, an exemplary embodiment of the present invention.

Interactive service portal 108 includes a communications portion 402, a processor 404 and a service database 406. Each of the elements of interactive service portal 108 are illustrated as individual devices, however, in some embodiments of the present invention at least two of communications portion 402, processor 404 and service database 406 may be combined as a unitary device.

Communications portion 402 may communicate bi-directionally with external entities (not shown) via a communication channel 408 and with processor 404 via a communication channel 410. Processor 404 may communicate bi-directionally with service database 406 via a communication channel 412.

Interactive service portal 108 may receive requests for service information and communicate responses to requests for service information. Non-limiting examples of requests for service information include available services, available proprietors, costs of services and schedule of services.

Interactive service portal 108 may communicate with external devices via communications portion 402. Non-limiting examples of networks which communications portion 402 may communicate with include Ethernet, optical fiber, Local Area Network (LAN), Wireless LAN (WLAN), Internet, cable, cellular, satellite and power line.

Communications portion 402 may communicate requests for service information to processor 404. Processor 404 may receive requests for service information, retrieve associated information from service database 406 via communication channel 412, process received and retrieved information and generate response for communication to communications portion 402. Communications portion 402 may receive service related information from processor 404 for communication to external entities via communication channel 408.

Interactive service portal 108 may receive and process requests for service related information.

FIG. 5 illustrates a detailed version of billing server 110, an exemplary embodiment of the present invention.

Billing server 110 includes a communications portion 502, a processor 504 and a billing database 506. Each of the elements of billing server 110 are illustrated as individual devices, however, in some embodiments of the present invention at least two of communications portion 502, processor 504 and billing database 506 may be combined as a unitary device.

Communications portion 502 may communicate bi-directionally with external entities (not shown) via a communication channel 508 and with processor 504 via a communication channel 510. Processor 504 may communicate bi-directionally with billing database 506 via a communication channel 512.

Billing server 110 may receive requests for billing related information, communicate responses to requests for billing related information and perform billing operations. Non-limiting examples of billing related information supported by billing server 110 include credit card, debit card and banking account. Furthermore, billing server 110 may communicate billing related requests to external entities. Non-limiting examples of requests to external entities include debit/credit of credit card, debit/credit of debit card and debit/credit of banking account.

Communications portion 502 may receive billing related requests from external entities via communication channel 508. Non-limiting examples of billing requests include requests for account status and requests for account balances. Communications portion 502 may communicate requests for billing related information requests to processor 504.

Processor 504 may receive billing related information requests from communications portion 502, retrieve associated information from billing database 506, processes received and retrieved information and communicate a response to communications portion 502.

Communications portion 502 may receive billing related information from processor 504 for communication to external entities via communication channel 508.

Billing server 110 may receive and process requests for billing related information and communicate billing related operations.

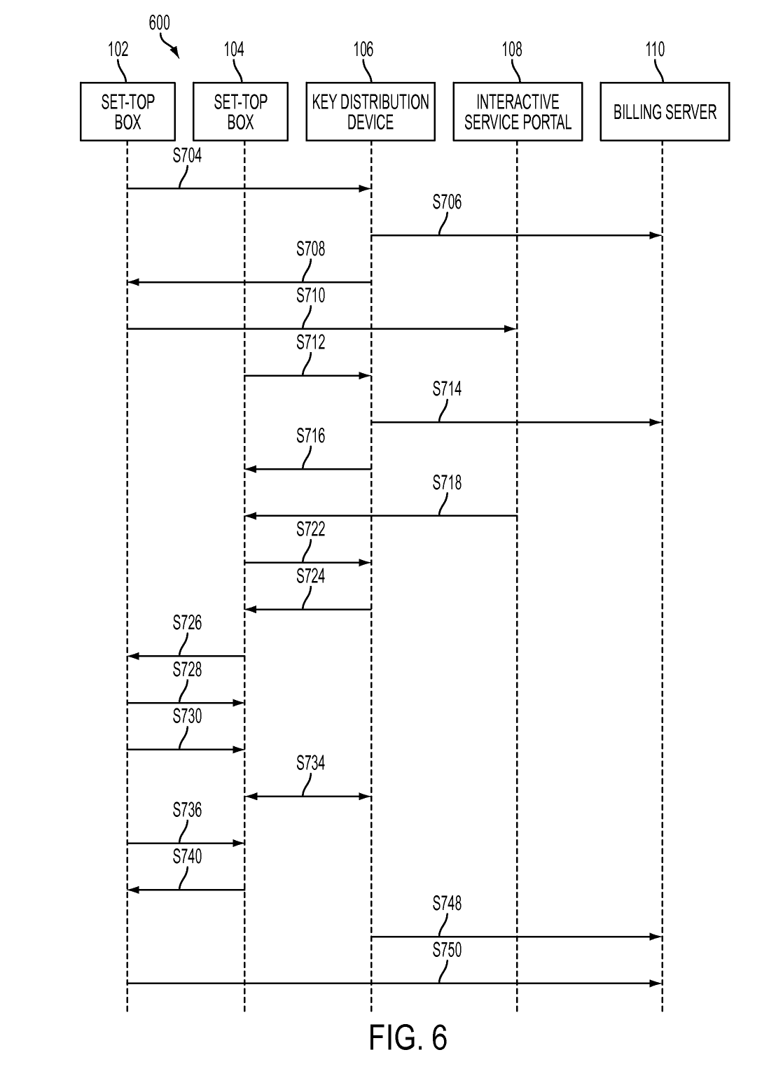

FIG. 6 presents a block diagram illustrating information flows as related to elements of FIG. 1, in accordance with an exemplary embodiment of the present invention.

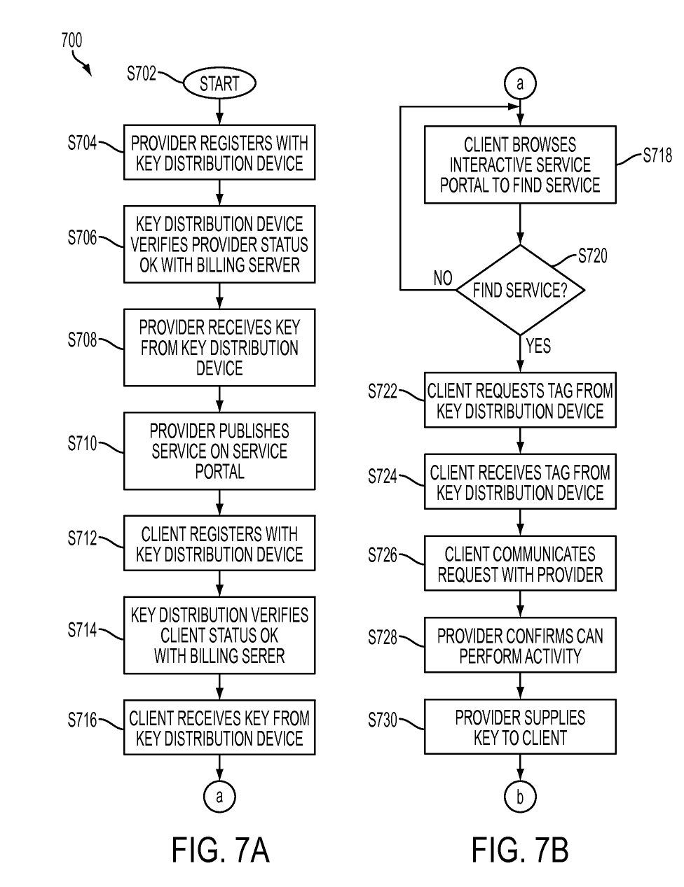

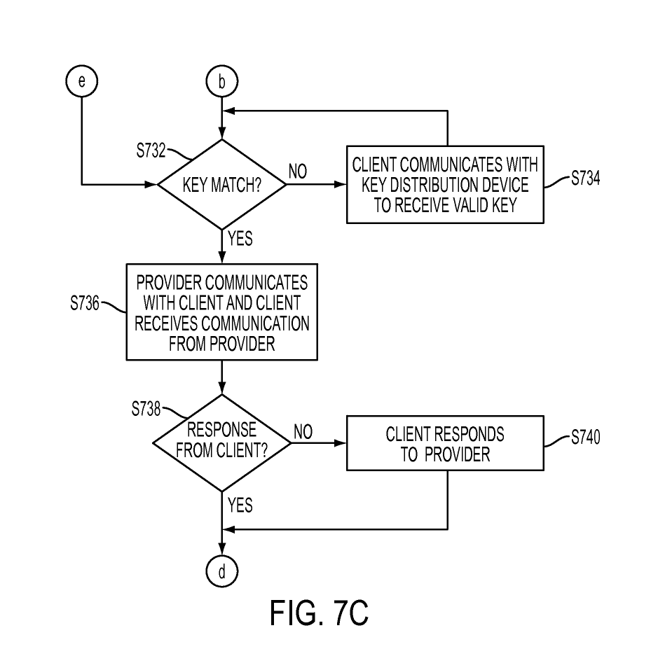

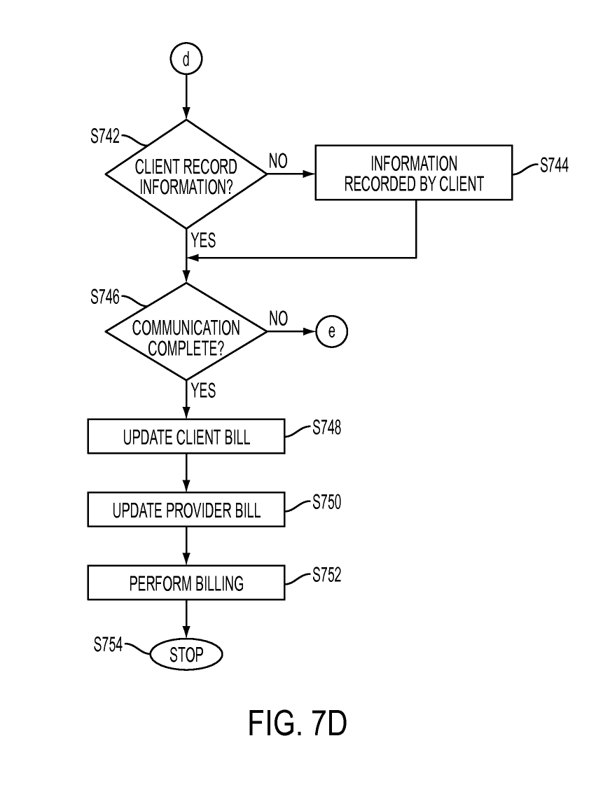

FIG. 6 contains some elements in common with FIG. 1. Common elements between FIG. 6 and FIG. 1 have been described previously and will not be described with reference to FIG. 6. FIG. 6 in tandem with FIG. 7A-D operates to present information flows as related to elements of FIG. 1.

A unidirectional flow of information may be received by key distribution device 106 from set-top box 102 as denoted by an arrow S704. A unidirectional flow of information may be received by billing server 110 from key distribution device 106 as denoted by an arrow S706. A unidirectional flow of information may be received by set-top box 102 from key distribution device 106 as denoted by an arrow S708. A unidirectional flow of information may be received by interactive service portal 108 from set-top box 102 as denoted by an arrow S710. A unidirectional flow of information may be received by key distribution device 106 from set-top box 104 as denoted by an arrow S712. A unidirectional flow of information may be received by billing server 110 from key distribution device 106 as denoted by an arrow S714. A unidirectional flow of information may be received by set-top box 104 from key distribution device 106 as denoted by an arrow S716. A unidirectional flow of information may be received by set-top box 104 from interactive service portal 108 as denoted by an arrow S718. A unidirectional flow of information may be received by key distribution device 106 from set-top box 104 as denoted by an arrow S722. A unidirectional flow of information may be received by set-top box 104 from key distribution device 106 as denoted by an arrow S724. A unidirectional flow of information may be received by set-top box 102 from set-top box 104 as denoted by an arrow S726. A unidirectional flow of information may be received by set-top box 104 from set-top box 102 as denoted by an arrow S728. A unidirectional flow of information may be received by set-top box 104 from set-top box 102 as denoted by an arrow S730. A bidirectional flow of information may be located between set-top box 104 and key distribution device 106 as denoted by an arrow S734. A unidirectional flow of information may be received by set-top box 104 from set-top box 102 as denoted in arrow S736. A unidirectional flow of information received by set-top box 102 from set-top box 104 as denoted as an arrow S740. A unidirectional flow of information received by billing server 110 from set-top box 104 as denoted by an arrow S748. A unidirectional flow of information received by billing server 110 from set-top box 102 as denoted by an arrow S750.

FIG. 6 illustrates flows of information for a student registering for, finding, selecting, paying for, receiving and recording a service from a tutor.

FIGS. 7A-D illustrate an example method 700 for interaction of the elements of communication system 100, in accordance with an aspect of the present invention.

Starting with FIG. 7A, in the example embodiment, method 700 starts (S702) and a provider registers with key distributor (S704). Provider (not shown) may view information as presented by data output 208 of set-top box 102 and enter and apply selections to set-top box 102 via data input 204.

Provider's set-top box 102 may then communicate and register with key distribution device 106 (S704). In order for provider's set-top box 102 to register with key distribution device 106, set-top box 102 may transmit a frame of data to key distribution device 106 by way of communication channel 114, communications network 112 and communication channel 118 indicating a request to register.

Key distribution device 106 may then communicate and verify an acceptable status for provider's set-top box 102 with billing server 110 (S706). In order to verify an acceptable status for provider's set-top box 102, key distribution device 106 may transmit a frame of data containing a status request for provider's set-top box 102 to billing server 110 by way of communication channel 118, communications network 112 and communication channel 122.

Provider's set-top box 102 may then receive a security key from key distribution device 106 (S708). Key distribution device 106 may send a frame of data with a security key to provider's set-top box 102 by way of communication channel 118, communications network 112 and communication channel 114 in order for provider's set-top box 102 to begin interaction with other elements of communication system 100.

Provider may then publish available services to interactive service portal 108 via set-top box 102 (S710). Set-top box 102 may transmit a frame of data to interactive service portal 108 by way of communication channel 114, communications network 112 and communication channel 120 with a list of available services.

Client's set-top box 104 may then communicate and register with key distribution device 106 (S712). Set-top box 104 may transmit a frame of data containing a request to register to key distribution device 106 by way of communication channel 116, communications network 112 and communication channel 118.

Key distribution device 106 may then communicate and verify an acceptable status for client's set-top box 104 with billing server 110 (S714). Key distribution device 106 may transmit a frame of data requesting status for client's set-top box 102 to billing server 110 by way of communication channel 118, communications network 112 and communication channel 122.

Client's set-top box 104 may then receive a security key from key distribution device 106 (S716). Key distribution device 106 may send a frame of data with a security key to provider's set-top box 102 by way of communication channel 118, communications network 112 and communication channel 114 in order for client's set-top box 104 to begin interaction with other elements of communication system 100.

Transitioning to FIG. 7B, the client then may browse available services listed on interactive service portal 108 by way of set-top box 104 (S718). Client's set-top box 104 may transmit a frame of data requesting a list of available services from interactive service portal 108 by way of communication channel 116, communications network 112 and communication channel 120. Furthermore, a listing of available services may then be communicated from interactive service portal 108 to client's set-top box 104 by way of communication channel 120, communications network 112 and communication channel 118.

The client may then determine, by way of set-top box 104, whether a desirable service is listed on interactive service portal 108 (S720). A received list of available services may be viewed by the client via data output 208 of set-top box 104 for determining whether an available service may be desirable for entering a subscription.

If it is determined that the client does not find a desirable service listed on interactive service portal 108, the client may again browse the Interactive Service Portal in order to find a suitable service (S718).

If it is determined that the client does find a desirable service listed on interactive service portal 108, client's set-top box 104 may then request a tag from key distribution device 106 (S722). Client's set-top box 104 may transmit a frame of data requesting a tag from key distribution device 106 by way of communication channel 116, communications network 112 and communication channel 118.

Furthermore, client's set-top box 104 may then receive a tag from key distribution device 106 (S724). Key distribution device 106 may transmit a frame of data containing a tag to client's set-top box 104 by way of communication channel 118, communications network 112 and communication channel 114.

Client's set-top box 104 may then request communication, security key and service with provider via set-top box 102 (S726). Client's set-top box 104 may transmit a frame or frames of data containing requests for communication, security key and service to provider via set-top box 102 by way of communication channel 116, communications network 112 and communication channel 114.

Provider may then confirm request for communication, security key and service via set-top box 102 with the client via set-top box 104 (S728). Provider's set-top box 102 may transmit a frame or frames of data containing confirmations of communication, and service to client's set-top box 104 by way of communication channel 114, communications network 112 and communication channel 116.

Furthermore, provider's set-top box 102 may then communicate a security key to client's set-top box 104 (S730). Provider's set-top box 102 may reply to request for security key to client's set-top box 104 by transmitting a frame or frames of data containing security key to client's set-top box 104 by way of communication channel 114, communications network 112 and communication channel 116.

Transitioning to FIG. 7C, validity for the security key supplied by provider' set-top box 102 may be determined by client's set-top box 104 (S732). Client's set-top box 104 may verify the security key provided by provider's set-top box 102. Non-limiting examples of parameters verified for validity for security key provide by provider's set-top box 102 include dates and times for validity and account up-to-date.

For a determination of an invalid security key, client's set-top box 104 may communicate with key distribution device 106 to obtain a valid security key (S734), with execution of method returning to validate security key (S732), following reception of a new security key. Client's set-top box 104 may transmit a frame of data containing a request for a security key to key distribution device 106 by way of communication channel 116, communications network 112 and communication channel 118.

For a determination of a valid security key, provider may communicate via set-top box 102 with the client via set-top box 104 (S736). Information may be received by client's set-top box 104 from provider's set-top box 102 by way of communication channel 114, communications network 112 and communication channel 116. The client may view received information by way of data output 208. Information to be viewed may encrypted and may be received by communication portion 202 via communication channel 214. Information to be viewed may be initially stored in memory 212 by way of communication channel 216, processor 206 and communication channel 224. Following storage of encrypted information in memory 212, information may be decrypted by way of processor 206, communication channel 222 and security portion 210, with decrypted information stored in memory 212. Decrypted information stored in memory 212 may be viewed by the client via data output 208 with information communicated to data output 208 by way of communication channel 224, processor 206 and communication channel 220.

Furthermore, it may be determined whether client has a response to be communicated with provider (S738).

If it is determined that the client is seeking to communicate a response to provider, the client may communicate a response via set-top box 104 to provider via set-top box 102 (S740). In response to information received from provider's set-top box 102, client's set-top box 104 may transmit a frame of data with response information by way of communication channel 116, communications network 112 and communication channel 114.

Transitioning to FIG. 7D, it may be determined whether the client seeks to record information communicated from provider (S742).

If it is determined that the client is seeking to record information communicated from provider, the client may record information, via set-top box 104, communicated by provider from set-top box 102 (S744).

Client's set-top box 104 may record information communicated from provider's set-top box 102 by way of communication channel 114, communications network 112 and communication channel 116. Information to be recorded is encrypted and may be received by communication portion 202 via communication portion 202. Information to be recorded may be initially stored in memory 212 by way of communication channel 216, processor 206 and communication channel 224. Following storage of encrypted information in memory 212, when in use, information is decrypted by way of processor 206, communication channel 222 and security portion 210. Encrypted information is stored in memory 212 and may be decrypted for use by the client via data output 208 (in accordance with the associated IP rights) with information communicated to data output 208 by way of communication channel 224, processor 206 and communication channel 220.

Furthermore, it may be determined whether the communication from provider via set-top box 102 to the client via set-top box 104 is completed (S746).

If it is determined that the communication is not complete, the provider and the client continue to communicate (S736).

If it is determined that the communication is complete, client billing information may be updated via set-top box 104 with billing server 110 (S748). Client billing information may be updated by set-top box 104 transmitting a frame of data containing billing information to billing server 110 by way of communication channel 116, communications network 112 and communication channel 122.

Provider billing information may then be updated via set-top box 102 with billing server (S750). Provider billing information may be updated by set-top box 102 transmitting a frame of data containing billing information to billing server 110 by way of communication channel 114, communications network 112 and communication channel 122.

Furthermore, billing may then be performed for provider and/or the client (S752). Non-limiting examples of performance of billing include debit credit card, debit bank account and generate and mail or email an invoice.

Lastly, method 700 stops (S754).

Some or all of the operations set forth in FIGS. 2-5 may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices. Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

A system and method in accordance with the present invention provides advantages over conventional interactive communication systems. In accordance with example embodiments of the present invention, a communication system may provide an interactive, secure, bi-directional and cost effective method for providing exchanges of information between users of media provider services. A user or a multiplicity of users may use the communication system to exchange information interactively, bi-directionally and securely with service providers. Furthermore, the communication system may provide billing services for users, service providers and media service providers. Furthermore, the communication system may provide record and playback capabilities for users.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A method of communicating within a system having a first device, a second device, a key distribution device and an interactive service portal device, said method comprising:
storing a tag within the interactive service portal device;
associating the tag with the first device;
registering the first device with the key distribution device;
associating, by way of the key distribution device, an encryption key with the first device;
accessing, by way of the second device, the tag;
providing information to the second device; and
establishing secure bi-directional interactive communication, corresponding to the tag, between the first device and the second device based on a relationship between the information and the encryption key.

2. The method of claim 1,
wherein the interactive service portal device includes a memory portion, and
wherein said storing a tag within the interactive service portal device comprises storing an accessible data portion within the memory portion, the accessible data portion being accessible by the second device.

3. The method of claim 2,
wherein said storing a tag within the interactive service portal device additionally comprises storing an identifying data portion within the memory portion, the identifying data portion identifying the first device, and
wherein said associating the tag with the first device comprises associating the identifying data portion with the first device.

4. The method of claim 3,
wherein the key distribution device includes a key memory portion having a key database therein, and
wherein said registering the first device with the key distribution device comprises storing a key within the key database.

5. The method of claim 4, wherein said associating, by way of the key distribution device, an encryption key with the first device comprises associating the key with the first device.

6. The method of claim 1,
wherein the interactive service portal device includes a memory portion, and
wherein said storing a tag within the interactive service portal device additionally comprises storing an identifying data portion within the memory portion, the identifying data portion identifying the first device, and
wherein said associating the tag with the first device comprises associating the identifying data portion with the first device.

7. The method of claim 6,
wherein the key distribution device includes a key memory portion having a key database therein, and
wherein said registering the first device with the key distribution device comprises storing a key within the key database.

8. The method of claim 7, wherein said associating, by way of the key distribution device, an encryption key with the first device comprises associating the key with the first device.

9. The method of claim 8,
wherein the interactive service portal device additionally includes an interface portion, and
wherein said accessing, by way of the second device, the tag comprises accessing the interface portion.

10. The method of claim 1,
wherein the interactive service portal device additionally includes an interface portion, and
wherein said accessing, by way of the second device, the tag comprises accessing the interface portion.

11. The method of claim 10, wherein said providing information to the second device comprises providing a service ticket from the key distribution device.

12. The method of claim 11, wherein said establishing secure bi-directional interactive communication, corresponding to the tag, between the first device and the second device based on a relationship between the information and the encryption key comprises the second device requesting the encryption key from the first device based on the service ticket and the first device sending the encryption key to the second device based on the request.

13. A device for use with a second device, a key distribution device and an interactive service portal device having a tag stored therein, the tag being associated with the second device, the first device being registered with the key distribution device and having an encryption key associated therewith, said device comprising:
a communication portion operable to access the tag and to obtain information from the interactive service portal;
a processing portion; and
a security portion operable to provide a relationship between the information and the encryption key,
wherein said processing portion is operable to instruct said communication portion to establish secure bi-directional interactive communication with the second device, corresponding to the tag, based on the relationship between the information and the encryption key.

14. The device of claim 13, wherein said processing portion is operable to associate the tag with the second device.

15. The device of claim 14, wherein said communication portion is operable to obtain a service ticket from the key distribution device.

16. The device of claim 15 wherein said communication portion is operable to request the encryption key from the second device based on the service ticket and to receive the encryption key from the second device based on the request.

17. A computer-readable media having computer-readable instructions stored thereon, the computer-readable instructions being capable of being read by a computer to use with a second device, a key distribution device and an interactive service portal device having a tag stored therein, the tag being associated with the second device, the first device being registered with the key distribution device and having an encryption key associated therewith, the computer-readable instructions being capable of instructing the computer to perform the method comprising:
accessing, via a communication portion, the tag;
obtaining, via a communication portion, information from the interactive service portal;
providing, via a security portion, a relationship between the information and the encryption key; and
establishing, via the communication portion, secure bi-directional interactive communication with the second device, corresponding to the tag, based on the relationship between the information and the encryption key.

18. The computer-readable media of claim 17, the computer-readable instructions being capable of instructing the computer to perform said method further comprising associating, via a processing portion, the tag with the second device.

19. The computer-readable media of claim 218, the computer-readable instructions being capable of instructing the computer to perform said method further comprising obtaining, via the communication portion, a service ticket from the key distribution device.

20. The computer-readable media of claim 19, the computer-readable instructions being capable of instructing the computer to perform said method further comprising:
requesting, via the communication portion, the encryption key from the second device based on the service ticket; and
receiving, via the communication portion, the encryption key from the second device based on the request.
